(19) United States
(12) Patent Application Publication
(10) Pub. No.: US 2023/0078887 A1
(43) Pub. Date: Mar. 16, 2023

(54) Lighted Display Sign Apparatus and Methods of Using the Same

(71) Applicant: Lawrence Ekeroth, McHenry, IL (US)

(72) Inventor: Lawrence Ekeroth, McHenry, IL (US)

(21) Appl. No.: 17/943,700

(22) Filed: Sep. 13, 2022

Related U.S. Application Data
(60) Provisional application No. 63/243,428, filed on Sep. 13, 2021.

(51) Int. Cl. G09F 13/08; G09F 19/22; G09F 13/00

(52) U.S. Cl. CPC G09F 13/08; G09F 19/227; G09F 13/005; G06K 19/06037

(57) ABSTRACT

Display sign apparatuses provide a visual indicator for drivers to quickly and easily find the location for a delivery, such as for the delivery of packages (such as, for example, from Amazon® or eBay®) and food or other like items, or for pick-up and drop off points for rideshare companies. Additional embodiments provide electronic features that allow a driver to quickly and easily determine a location, such as by using wireless communication protocols, such as, for example, RF tags, Bluetooth enabled communication modules, or other like electronic elements. Methods of using the same are further provided.

### CROSS-REFERENCE TO RELATED APPLICATIONS

The present invention claims priority to U.S. Prov. Pat. App. No. 63/243,428, titled “Lighted Display Sign Apparatus and Methods of Using the Same,” filed Sep. 13, 2022, which is incorporated herein by reference in its entirety.

### TECHNICAL FIELD

The present invention relates to display sign apparatuses. Specifically, the display sign apparatuses provide a visual indicator for drivers to quickly and easily find the location for a delivery, such as for the delivery of packages (such as, for example, from Amazon® or eBay®) and food or other like items, or for pick-up and drop off points for rideshare companies. Additional embodiments provide electronic features that allow a driver to quickly and easily determine a location, such as by using wireless communication protocols, such as, for example, RF tags, Bluetooth enabled communication modules, or other like electronic elements. Methods of using the same are further provided.

### BACKGROUND

The delivery of items to houses, businesses, or other like locations is an important and prominent part of life throughout the world. Indeed, one can purchase practically anything from online retailers and in many cases delivery can occur within a day or two. Moreover, food delivery has also increased incredibly over the past several years, and even more so during the coronavirus pandemic. Having items delivered is often convenient, generally quick, and oftentimes free of cost to the consumer. Finally, rideshare companies have grown and many utilize these companies for direct pick-up and drop-off at specific locations.

However, the service of delivering items is not without issues and problems that may crop up from time to time. Specifically, delivery drivers and/or rideshare drivers can have difficulty finding the right delivery or pick-up/drop-off locations. Oftentimes, a driver simply has an address to deliver items or pick-up/drop-off users and in many cases the specific location is difficult to locate. This may be particularly true with building and doors that are not labelled or even mis-labelled. Moreover, in high density living quarters, such as apartment buildings, it may be difficult for a driver to know exactly where to go.

A need, therefore, exists for an improved display apparatus. Specifically, a need exists for an improved display apparatus that may aid a driver in locating a delivery or pick-up/drop-off location. More specifically, a need exists for an improved display apparatus that provide immediate information to a driver as to the proper location of a delivery or pick-up/drop-off location.

Normally, buildings and houses are marked with address numbers that a driver uses to find a location. However, the numbers may be difficult to discern especially if blocked or at night. Oftentimes, it is quite difficult to ascertain address numbers in the dark or from a distance, such as from the street. A need exists for an improved display apparatus that is easy to discern. Specifically, a need exists for an improved display apparatus that is lighted so that information useful to a driver is easily seen. Moreover, a need exists for an improved display apparatus that can be seen at night and/or from a distance, such as from the street.

In many cases, even if a driver can discern address numbers on a building or house, he or she may still have reason to doubt whether he or she has found the correct location. For example, there may be multiple doors near an address, and so a driver may not know precisely which door to delivery the item. A need, therefore, exists for an improved display apparatus that provides verification to a driver that the location is correct. Specifically, a need exists for an improved display apparatus that is encoded with a unique identification that a driver may independently match with information he or she has.

In addition, sometimes locations can be hidden or otherwise obscured so much that a driver may have no idea where to even begin to deliver an item or pick-up/drop-off a rider. A need, therefore, exists for an improved display apparatus that allows a driver to home in on the location, especially from a distance. Specifically, a need exists for an improved display apparatus comprising electronic communication modules, such as wireless RF tags and/or Bluetooth communication modules, to allow a driver to locate a location, especially when address numbers are difficult to see.

### SUMMARY OF THE INVENTION

The present invention relates to display sign apparatuses. Specifically, the display sign apparatuses provide a visual indicator for drivers to quickly and easily find the location for a delivery, such as for the delivery of packages (such as, for example, from Amazon® or eBay®) and food or other like items, or for pick-up and drop off points for rideshare companies. Additional embodiments provide electronic features that allow a driver to quickly and easily determine a location, such as by using wireless communication protocols, such as, for example, RF tags, Bluetooth enabled communication modules, or other like electronic elements. Methods of using the same are further provided.

To this end, in an embodiment of the present invention, a display sign apparatus is provided. The display sign apparatus comprises: a housing having an illumination element therein, and at least a portion of the housing being transparent or translucent, wherein the housing comprises indicia thereon on the transparent or translucent portion for viewing of the same, and further indicia including a building address and a unique code thereon, wherein the unique code is configured to be scanned by a driver for confirmation of a delivery location.

In an embodiment, the display sign apparatus comprises: a switch for illuminating the illumination element therein.

In an embodiment, the switch is remotely activated via remote control.

In an embodiment, the indicia on the transparent or translucent portion form a company symbol.

In an embodiment, the indicia show an address number for a location where the display sign apparatus is displayed.

In an embodiment, the unique code is a scannable QR code configured to be scanned by a handheld scanning device.

In an embodiment, the unique code is an identifier associated with a location where the display sign apparatus is located.

In an embodiment, the display sign apparatus further comprises: an electronic location element comprising a communication protocol for determining a location of the display sign apparatus.

In an embodiment, the electronic location element is configured to emit a wireless signal.

In an embodiment, the wireless signal is selected from an RF signal, a Bluetooth signal, and an IR signal.

In an embodiment, the wireless signal is configured to communicate with location triangulating means for determining a location for the display sign apparatus.

In an alternate embodiment of the present invention, a method of delivery to a location is provided. The method comprises the steps of: providing a display sign apparatus a housing having an illumination element therein, and at least a portion of the housing being transparent or translucent, wherein the housing comprises indicia thereon on the transparent or translucent portion for viewing of the same, and further indicia including a building address and a unique code thereon, wherein the unique code is configured to be scanned by a driver for confirmation of a delivery location; delivering a product to a location having the display sign apparatus displayed at the location; scanning the unique code via a handheld scanning device; and verifying the location of the location using the unique code.

In an embodiment, the display sign apparatus is illuminated.

In an embodiment, the display sign is illuminated via a switch.

In an embodiment, the switch is controlled by a remote control.

In an embodiment, the unique code is a scannable QR code configured to be scanned by a handheld scanning device.

In an embodiment, the unique code is an identifier associated with a location where the display sign apparatus is located.

In an embodiment, the display sign apparatus comprises an electronic location element comprising a wireless communication protocol for determining a location of the display sign apparatus, and further comprises the steps of: emitting a wireless signal; and finding a location of the display sign apparatus using the wireless signal.

In an embodiment, the method further comprises the step of: receiving the wireless signal at a handheld device wherein the wireless signal directs the handheld device to locate the display sign apparatus.

In an embodiment, the method further comprises the step of: triangulating the location of the display sign apparatus with the wireless signal.

It is, therefore, an advantage and objective of the present invention to provide an improved display apparatus.

Specifically, it is an advantage and objective of the present invention to provide an improved display apparatus that may aid a driver in locating a location for delivery or one or more items, or for picking up and/or dropping off riders.

More specifically, it is an advantage and objective of the present invention to provide an improved display apparatus that provide immediate information to a driver as to the proper location of a delivery or pick-up/drop-off.

Further, it is an advantage and objective of the present invention to provide an improved display apparatus that is easy to discern, especially from a distance.

Specifically, it is an advantage and objective of the present invention to provide an improved display apparatus that is lighted so that information useful to a driver is easily seen.

Moreover, it is an advantage and objective of the present invention to provide an improved display apparatus that can be seen at night and/or from a distance, such as from the street.

Still further, it is an advantage and objective of the present invention to provide an improved display apparatus that provides verification to a delivery driver that the delivery location is correct.

Specifically, it is an advantage and objective of the present invention to provide an improved display apparatus that is encoded with a unique identification that a driver may independently match with information he or she has.

In addition, it is an advantage and objective of the present invention to provide an improved display apparatus that allows a delivery driver to home in on the location, especially from a distance.

Specifically, it is an advantage and objective of the present invention to provide an improved display apparatus comprising electronic communication modules, such as wireless RF tags and/or Bluetooth communication modules, to allow a driver to locate a location, especially when address numbers are difficult to see.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIGS. 1A-1C illustrate various views of a lighted display sign apparatus in an embodiment of the present invention.

FIG. 2 illustrates a lighted display sign apparatus attached to a building in an embodiment of the present invention.

### DETAILED DESCRIPTION OF THE PRESENTLY PREFERRED EMBODIMENTS

The present invention relates to display sign apparatuses. Specifically, the display sign apparatuses provide a visual indicator for drivers to quickly and easily find the location for a delivery, such as for the delivery of packages (such as, for example, from Amazon® or eBay®) and food or other like items, or for pick-up and drop off points for rideshare companies. Additional embodiments provide electronic features that allow a driver to quickly and easily determine a location, such as by using wireless communication protocols, such as, for example, RF tags, Bluetooth enabled communication modules, or other like electronic elements. Methods of using the same are further provided.

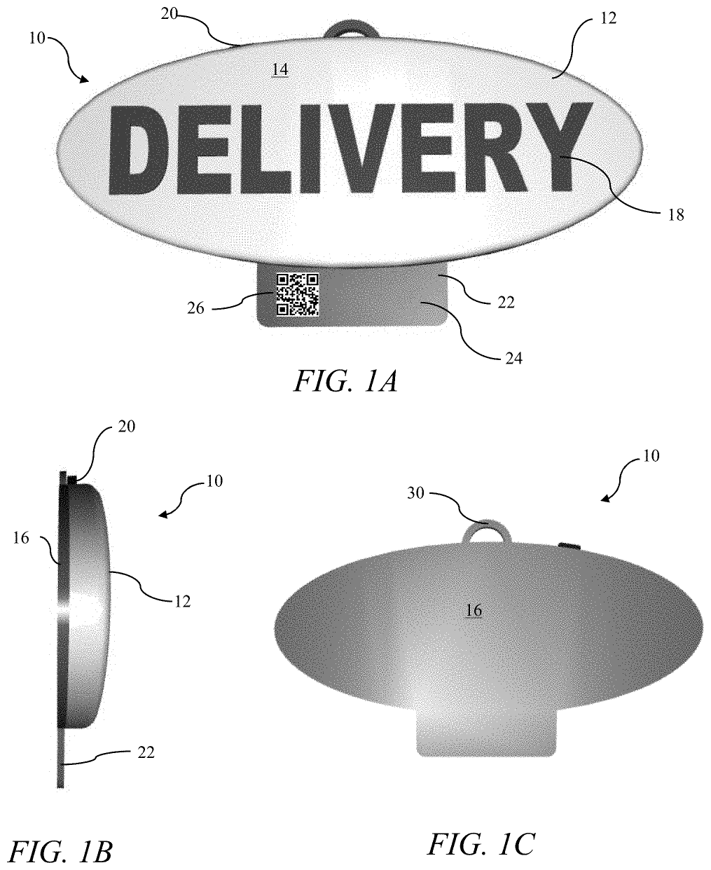

Now referring to the drawings, FIGS. 1A-1C illustrate a lighted display sign apparatus 10 in an embodiment of the present invention. The lighted display sign apparatus comprises a housing 12 having a front portion 14 and a rear portion 16 that may be attached together to form a space therebetween (not shown). Of course, the housing 12 may be formed from any number of parts or portions and the present invention should not be limited as described herein. The front portion 14 may be made from a transparent or a translucent material, or otherwise may have a transparent or a translucent section therein so that an illumination element, such as one or more light bulbs, LEDs, or other lighting elements, may be seen through the transparent or translucent material.

In addition, the front portion 14 may further comprise indicia 18, such as lettering or one or more symbols, that may be opaque and block the light from the illumination element such that the indicia may be more readily viewable to a viewer. Thus, a delivery driver or a rideshare driver may more easily view the display sign apparatus 10 due to its illumination and may more easily view the indicia 18 thereon. The indicia 18 may, for example, spell out “DELIVERY”, as illustrated in FIG. 1A, or may include any other letters or symbols to better signal to a driver the location. For example, if the display sign apparatus 10 is for a specific delivery company, such as, for example, Amazon.com, then the word “AMAZON” may be displayed thereon. Other examples may include rideshare companies, pizza companies, or other like companies where delivery or pick-up/drop-off may occur.

The illumination element may be activated via a simple switch 20. Therefore, when a delivery or a rideshare is expected, a user may simply activate the illumination element via the switch 20, thereby providing a viewable signal to a driver. Alternatively, the illumination element may be activated remotely, such as with a remote control from within or outside the building. The remote control (not shown) may be hard-wired or wireless, may include a push-button, and/or may include various communication protocols, such as RF, Wi-Fi, or Bluetooth, for example.

The housing 12 may further have a flat portion 22 having a flat surface thereon on which may be printed additional indicia, such as an address number 24 and a unique code 26. Thus, the address number may be utilized by a driver to determine whether he or she is at the correct location based on the address. An address, however, is not often a unique code, as it is typically only a number that may be replicated on other display apparatuses on different streets. Therefore, the flat portion 22 may further include the unique code 26 that may be readily discernible or scanned by a driver for confirmation of the delivery location. For example, the unique code 26 may be a scannable QR code that is easily scanned via a handheld device, such as a smart phone or the like. Thus, while a driver may view the address number 24 thereon, he or she may confirm the location by scanning the QR code, presenting a unique identifier that may be associated with the delivery or pick-up/drop-off location. If the scan of the unique code 26 matches a code associated with the delivery or pick-up/drop-off location, then the driver is assured that the location is correct.

The flat portion 22 may also be illuminated, such as via a light bulb or LED that is on the housing 12 and aimed at the flat portion 22 so that a driver may more readily view the indicia thereon.

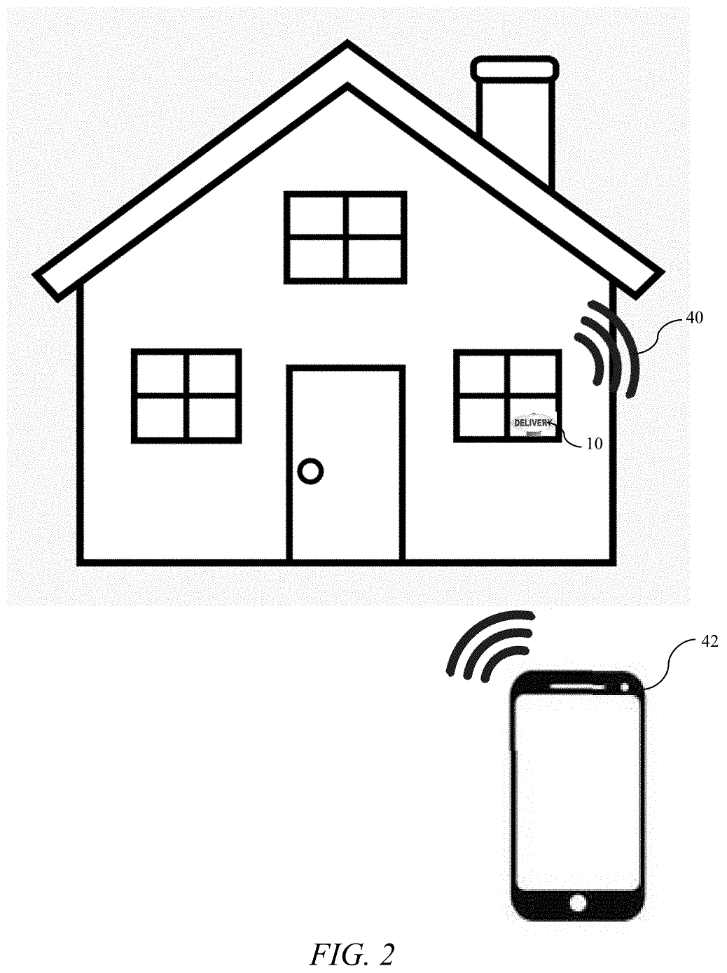

To attach the display sign apparatus 10 to a building or other location that is readily and easily viewable by a driver, as illustrated in FIG. 2, the housing may comprise a ring 30 for hanging the apparatus 10. Thus, a nail, screw, hook, or other element may be attached to a building and the display sign apparatus 10 may hang on the nail, screw, hook, or other element. Of course, any number of rings or other connection elements may be on the housing 12 and the present invention should not be limited as described herein or shown in FIGS. 1A-1C.

Further, the rear portion 16 of the housing 12 may comprise other attachment elements, such as magnets, hook and loop fasteners, tack, suction cups or other like fastening or connecting elements for holding the display sign apparatus 10 to a wall or similar surface.

As illustrated in FIG. 2, a display sign apparatus 10 is shown attached to a window, such as inside a window of a dwelling, although the apparatus 10 may be attached in any other location apparent to one of ordinary skill in the art, such as to an outside wall of the dwelling, on the front door thereof, above the front door thereof, or in any other conspicuous location. A driver may view the apparatus 10, which may be illuminated, thereby providing an indication that the dwelling expects a delivery or that a rideshare user expects to be picked up or dropped off. In addition, as noted above, the building address may be presented thereon, and a unique code may be viewable, such as a QR code, for scanning and confirming the location. The display sign apparatus 10 may include other location elements, such as electronic wireless detection means to allow a driver to more easily home in on the delivery or pick-up/drop-off location. For example, the apparatus 10 may comprise a communication element that may send a signal 40 that may be detected by a delivery driver via a handheld device 42, which may be a smart phone, tablet computer, or other like handheld device that may detect the signal 40 emanating from the apparatus 10. The signal may be RF, Bluetooth, IR, or other like communication protocol. The driver may be guided toward the apparatus 10 by homing in on the signal 40.

Alternatively, the apparatus 10 may include an element for communicating with GPS satellites or cell phone towers for triangulating its location for a driver. Thus, a driver may utilize the GPS or cellphone triangulation information for determining the location of the apparatus 10 and, therefore, the location.

Alternatively, or in addition, the display apparatus 10 may be tied to a specific geographic location that may be stored in a database. For example, a user may place the display apparatus 10 in a conspicuous location and then utilize his or her smartphone to set a geographic location for the apparatus 10, which may be stored and usable by a driver. Thus, when a driver searches for the location, he or she may utilize the stored geographic location information of the apparatus 10 and utilize the geographic location information to obtain specific directions, placement on a map, or other like information to help determine the precise location of the location.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

I claim:

1. A display sign apparatus comprising:
a housing having an illumination element therein, and
at least a portion of the housing being transparent or translucent
wherein the housing comprises indicia thereon on the transparent or translucent portion for viewing of the same, and further indicia including a building address and a unique code thereon, wherein the unique code is configured to be scanned by a driver for confirmation of a delivery location.

2. The display sign apparatus of claim 1 comprising:
a switch for illuminating the illumination element therein.

3. The display sign apparatus of claim 1 wherein the switch is remotely activated via remote control.

4. The display sign apparatus of claim 1 wherein the indicia on the transparent or translucent portion form a company symbol.

5. The display sign apparatus of claim 1 wherein the indicia form an address number for a location where the display sign apparatus is displayed.

6. The display sign apparatus of claim 1 wherein the unique code is a scannable QR code configured to be scanned by a handheld scanning device.

7. The display sign apparatus of claim 1 wherein the unique code is an identifier associated with a location where the display sign apparatus is located.

8. The display sign apparatus of claim 1 further comprising:
an electronic location element comprising a communication protocol for determining a location of the display sign apparatus.

9. The display sign apparatus of claim 8 wherein the electronic location element is configured to emit a wireless signal.

10. The display sign apparatus of claim 9 wherein the wireless signal is selected from an RF signal, a Bluetooth signal, and an IR signal.

11. The display sign apparatus of claim 9 wherein the wireless signal is configured to communicate with location triangulating means for determining a location for the display sign apparatus.

12. A method of delivery to a location, the method comprising the steps of:
providing a display sign apparatus a housing having an illumination element therein, and at least a portion of the housing being transparent or translucent, wherein the housing comprises indicia thereon on the transparent or translucent portion for viewing of the same, and further indicia including a building address and a unique code thereon, wherein the unique code is configured to be scanned by a driver for confirmation of a delivery location;
delivering a product to a location having the display sign apparatus displayed at the location;
scanning the unique code via a handheld scanning device; and
verifying the location of the location using the unique code.

13. The method of claim 12 wherein the display sign apparatus is illuminated.

14. The method of claim 12 wherein the display sign is illuminated via a switch.

15. The method of claim 14 wherein the switch is controlled by a remote control.

16. The method of claim 12 wherein the unique code is a scannable QR code configured to be scanned by a handheld scanning device.

17. The method of claim 12 wherein the unique code is an identifier associated with a location where the display sign apparatus is located.

18. The method of claim 12 wherein the display sign apparatus comprises an electronic location element comprising a wireless communication protocol for determining a location of the display sign apparatus, and further comprising the steps of:
emitting a wireless signal; and
finding a location of the display sign apparatus using the wireless signal.

19. The method of claim 18 further comprising the step of:
receiving the wireless signal at a handheld device wherein the wireless signal directs the handheld device to locate the display sign apparatus.

20. The method of claim 18 further comprising the step of:
triangulating the location of the display sign apparatus with the wireless signal.
